(19) United States
(12) Patent Application Publication
(10) Pub. No.: US 2026/0230297 A1
(43) Pub. Date: Aug. 6, 2026

(54) METHODS, SYSTEMS, AND COMPUTER READABLE MEDIA FOR TESTING PRECISION TIME PROTOCOL (PTP) DEVICES WITH ADAPTIVE PTP SYNCHRONIZATION INTERVAL OPTIMIZATION

(71) Applicant: Keysight Technologies, Inc., Santa Rosa, CA (US)

(72) Inventors: Tanuman Bhaduri, Kolkata (IN); Pratick Kumar De, Kolkata (IN); Narottam Pattanayak, Kolkata (IN); Mriganka Mouli Ghosh, Hooghly (IN)

(21) Appl. No.: 19/576,038

(22) Filed: Mar. 24, 2026

(51) Int. Cl. H04L 7/00; H04J 3/06

(52) U.S. Cl. CPC H04L 7/0037; H04J 3/0667

(57) ABSTRACT

A method for testing a PTP device under test with PTP sync interval optimization incudes signaling, by a PTP grand master on a test tool and with a PTP slave on a PTP DUT, to synchronize a clock of the PTP DUT with a first clock of the PTP test tool and signaling, by a PTP slave on the PTP test tool and with a PTP master on the PTP DUT, to synchronize a second clock of the PTP test tool with the clock of the PTP DUT. The method further includes measuring a timing error on by the PTP slave of the PTP test tool, automatically adjusting a sync message transmission interval, and repeating PTP synchronization signaling between the PTP test tool and the PTP DUT until the timing error measured by the PTP slave on PTP test tool reaches a desired value.

### TECHNICAL FIELD

The subject matter described herein relates to testing network devices. More particularly, the subject matter described herein relates to methods, systems, and computer readable media for testing PTP devices with adaptive PTP synchronization interval optimization.

### BACKGROUND

Currently, multiple time synchronization profiles for time sensitive applications are used across industries to detect and correct time discrepancies between time-aware devices, all leveraging the Generic Precision Time Protocol (gPTP). Examples include:
IEEE 60802 for industrial Ethernet
IEEE 802.1DG for automotive Ethernet
IEEE 802.1DP for onboard aerospace Ethernet
IEEE 802.1 CM for 5G fronthaul Ethernet

While these profiles use the same underlying protocol, they define different time error thresholds based on their specific application requirements. This variation creates challenges for vendors in configuring appropriate gPTP message intervals to accurately detect time errors.

In gPTP, the sync intervals are configurable by the device administrator and are communicated through the message interval request TLV in signaling messages. The gPTP state machine then transmits and receives sync messages at the specified intervals to calculate clock error.

However, if the chosen intervals do not yield accurate clock error measurements, manual intervention is required to adjust the intervals and re-evaluate the results. This trial-and-error process is inefficient and burdensome.

In light of these and other difficulties, there exists a need for improved methods, systems, and computer readable media for determining an optimal time synchronization interval of a PTP device under test.

### SUMMARY

A method for testing a precision time protocol (PTP) device under test with PTP sync interval optimization includes implementing a PTP grand master on a first port of a PTP test tool. The method further includes implementing a PTP slave on a second port of the PTP test tool. The method further includes signaling, by the PTP grand master and with a PTP slave implemented on a first port of a PTP DUT, to synchronize a clock of the PTP DUT with a first clock of the PTP test tool. The method further includes signaling, by the PTP slave implemented on the second port of the PTP test tool and with a PTP master implemented on a second port of the PTP DUT, to synchronize a second clock of the PTP test tool with the clock of the PTP DUT. The method further includes measuring a timing error on the second port of the PTP test tool. The method further includes automatically adjusting a sync message transmission interval and repeating PTP synchronization signaling between the PTP test tool and the PTP DUT until the timing error measured at the second port of the PTP test tool reaches a desired value.

According to another aspect of the subject matter described herein, signaling, by the PTP grand master, includes transmitting sync and follow_up message to the PTP slave implemented on the first port of the PTP DUT, receiving a delay_request message from the PTP slave implemented on the first port of the PTP DUT, and transmitting a delay_response message to the PTP slave implemented on the first port of the PTP DUT.

According to another aspect of the subject matter described herein, signaling, by the PTP slave implemented on the second port of the PTP test tool, includes receiving sync and follow_up messages from the PTP master implemented on the second port of the PTP DUT and transmitting a delay_request message from the PTP slave implemented on the second port of the PTP test tool to the PTP master implemented on the second port of the PTP DUT.

According to another aspect of the subject matter described herein, measuring the timing error at the second port of the PTP test tool includes calculating a timing offset value at the second port of the PTP test tool.

According to another aspect of the subject matter described herein, calculating the timing offset value includes calculating the timing offset value as:

timing offset value=((T2−T1)−(T4−T3))/2,
where T2 is a time of receipt of a sync message by the PTP slave implemented on the second port of the PTP test tool, T1 is a transmission time of the sync message by the PTP master implemented on the second port of the PTP DUT, T3 is a transmission time of a delay_request message by the PTP slave implemented on the second port of the PTP test tool, and T4 is a time of receipt of the delay_request message by the PTP master implemented on the second port of the PTP DUT.

According to another aspect of the subject matter described herein, automatically adjusting the sync message transmission interval includes transmitting a signaling message from the second port of the PTP test tool to the second port of the PTP DUT where the signaling message encodes an updated sync message interval.

According to another aspect of the subject matter described herein, automatically adjusting the sync message transmission interval includes automatically and iteratively increasing the sync message transmission interval until the timing error exceeds a threshold value.

According to another aspect of the subject matter described herein, the method includes setting the sync message transmission interval to a last sync message transmission interval prior to the timing error exceeding the threshold value.

According to another aspect of the subject matter described herein, automatically adjusting the sync message transmission interval includes automatically and iteratively decreasing the sync message transmission interval until a change in the timing error is less than a threshold value.

According to another aspect of the subject matter described herein, automatically adjusting the sync message transmission interval includes automatically and iteratively searching for an optimal value for the sync message transmission interval using a binary search algorithm.

According to another aspect of the subject matter described herein, a system for testing a precision time protocol (PTP) device under test with PTP sync interval optimization is provided. The system includes a PTP test tool including first and second ports, at least one processor, and a memory. The system further includes a PTP grand master by the at least one processor on the first port of the PTP test tool. The system further includes a PTP slave implemented by the at least one processor on the second port of the PTP test tool. The PTP grand master is configured to signal with a PTP slave implemented on a first port of a PTP DUT, to synchronize a clock of the PTP DUT with a first clock of the PTP test tool. The PTP slave is configured to synchronize a second clock of the PTP test tool with the clock of the PTP DUT. The PTP test tool is configured to measure a timing error on the second port of the PTP test tool, automatically adjust a sync message transmission interval, and repeat PTP synchronization signaling between the PTP test tool and the PTP DUT until the timing error measured at the second port of the PTP test tool reaches a desired value.

According to another aspect of the subject matter described herein, the PTP grand master is configured to perform the signaling with the PTP slave implemented on the first port of the PTP DUT by transmitting sync and follow_up message to the PTP slave implemented on the first port of the PTP DUT, receiving a delay_request message from the PTP slave implemented on the first port of the PTP DUT, and transmitting a delay_response message to the PTP slave implemented on the first port of the PTP DUT.

According to another aspect of the subject matter described herein, the PTP slave implemented on the second port of the PTP test tool is configured to perform the signaling with the PTP master by receiving sync and follow_up messages from the PTP master implemented on the second port of PTP DUT and transmitting a delay_request message from the PTP slave implemented on the second port of the PTP test tool to the PTP master implemented on the second port of the PTP DUT.

According to another aspect of the subject matter described herein, the PTP test tool is configured to measure the timing error at the second port of the PTP test tool by calculating a timing offset value at the second port of the PTP test tool.

According to another aspect of the subject matter described herein, the PTP test tool is configured to calculate the timing offset value by calculating the timing offset value as:

timing offset value=((T2−T1)−(T4−T3))/2,
where T2 is a time of receipt of a sync message by the PTP slave implemented on the second port of the PTP test tool, T1 is a transmission time of the sync message by the PTP master implemented on the second port of the PTP DUT, T3 is a transmission time of a delay_request message by the PTP slave implemented on the second port of the PTP test tool, and T4 is a time of receipt of the delay_request message by the PTP master implemented on the second port of the PTP DUT.

According to another aspect of the subject matter described herein, the PTP test tool is configured to automatically adjust the sync message transmission interval by transmitting a signaling message from the second port of the PTP test tool to the second port of the PTP DUT where the signaling message encodes an updated sync message interval.

According to another aspect of the subject matter described herein, the PTP test tool is configured to automatically adjust the sync message transmission interval by automatically and iteratively increasing the sync message transmission interval until the timing error exceeds a threshold value.

According to another aspect of the subject matter described herein, the PTP test tool is configured to automatically adjust the sync message transmission interval by automatically and iteratively decreasing the sync message transmission interval until a change in the timing error is less than a threshold value.

According to another aspect of the subject matter described herein, the PTP test tool is configured to automatically adjust the sync message transmission interval by automatically and iteratively searching for an optimal value for the sync message transmission interval using a binary search algorithm.

According to another aspect of the subject matter described herein, non-transitory computer readable medium having stored thereon executable instructions that when executed by a processor of a computer control the computer to perform steps is provided. The steps include implementing a precision time protocol (PTP) grand master on a first port of a PTP test tool;
implementing a PTP slave on a second port of the PTP test tool. The steps further include implementing a PTP slave on a second port of the PTP test tool. The steps further include signaling, by the PTP grand master and with a PTP slave implemented on a first port of a PTP DUT, to synchronize a clock of the PTP DUT with a first clock of the PTP test tool. The steps further include signaling, by the PTP slave implemented on the second port of the PTP test tool and with a PTP master implemented on a second port of the PTP DUT, to synchronize a second clock of the PTP test tool with the clock of the PTP DUT. The steps further include measuring a timing error on the second port of the PTP test tool. The steps further include automatically adjusting a sync message transmission interval and repeating PTP synchronization signaling between the PTP test tool and the PTP DUT until the timing error measured at the second port of the PTP test tool reaches a desired value.

The subject matter described herein may be implemented in hardware, software, firmware, or any combination thereof. As such, the terms “function” or “module” as used herein refer to hardware, software, and/or firmware for implementing the feature being described. In one exemplary implementation, the subject matter described herein may be implemented using a computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Examples of the subject matter described herein will now be explained with reference to the accompanying drawings, wherein like reference numerals represent like parts, of which:

FIG. 1 is a diagram of a network test system for testing a PTP device and adaptively determining an optimal PTP sync message interval;

FIG. 2 is a message flow diagram illustrating exemplary messages exchanged between a PTP test tool and a PTP DUT in synchronizing clock values and iteratively and automatically updating the sync message transmission interval; and

FIG. 3 is a flow chart illustrating an exemplary process for automatic PTP sync message transmission interval optimization.

### DETAILED DESCRIPTION

### Introduction

Time Error Detection in gPTP Using Timestamped Messages

The Generic Precision Time Protocol (gPTP) employs a set of timestamped messages—sync, follow up, peer delay request, peer delay response, and peer delay follow up—to measure time discrepancies between time-aware devices. These messages enable devices to calculate clock error relative to their peers.

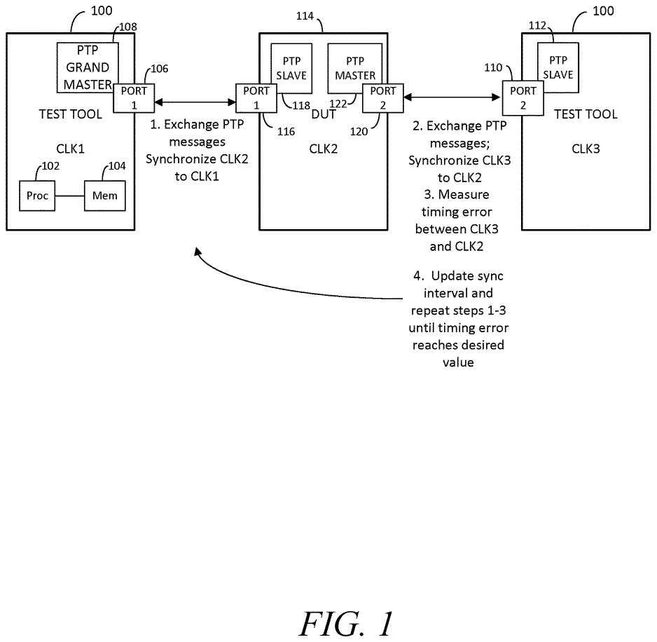

FIG. 1 is a diagram of a network test tool for testing a PTP device and adaptively determining an optimal PTP synchronization interval. Referring to FIG. 1, a PTP test tool 100 includes at least one processor 102 and memory 104. PTP test tool 100 includes a first port 106 on which a PTP grand master 108 is implemented. PTP test tool 100 includes a second port 110 on which a PTP slave 112 is implemented. A device under test (DUT) 114 includes a first port 116 on which a PTP slave 118 is implemented and a second port 120 on which a PTP master 122 is implemented.

Test tool 100 is configured to perform PTP synchronization interval optimization, the overall steps of which will now be described. Referring to the message flow illustrated in FIG. 1, in step 1, PTP grand master 108 of test tool 100 exchanges PTP timing synchronization messages with PTP slave 118 of DUT 114 to synchronize clock CLK2 of DUT 114 with clock CLK1 of test tool 100. In step 2, PTP master 122 of PTP DUT 114 exchanges PTP timing synchronization messages with PTP slave 112 of test tool 100 to synchronize CKL3 of test tool 100 with CLK2 of PTP DUT 114. In step 3, test tool 100 measures the timing error on port 2 110. In step 4, test tool 100 updates the sync message transmission interval and repeats steps 1-3 until the timing error reaches a desired value.

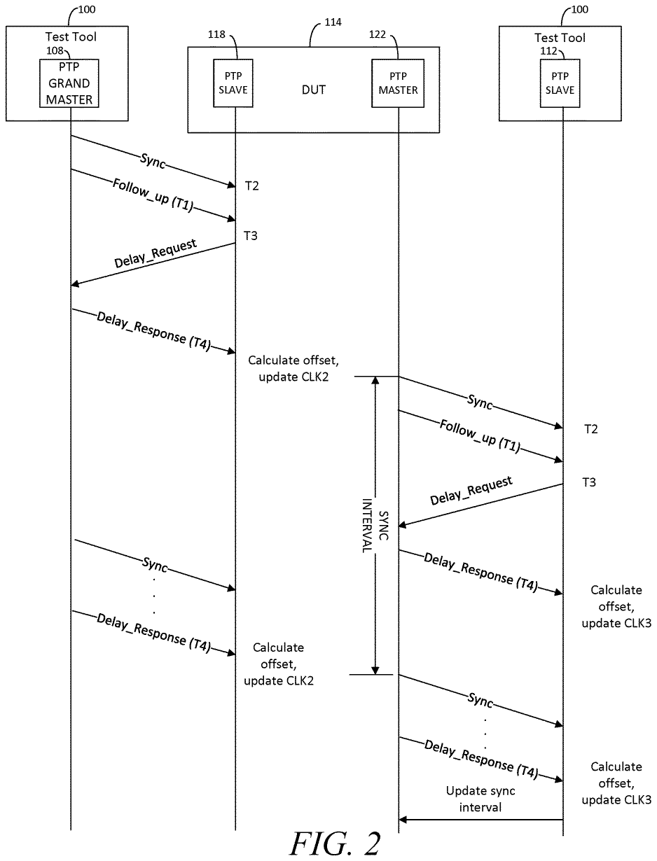

FIG. 2 is a message flow diagram illustrating exemplary messages exchanged between PTP test tool 100 and PTP DUT 114 in synchronizing clock values and iteratively and automatically updating the sync message transmission interval. Referring to FIG. 2, PTP grand master 108 of test tool 100 sends a sync message to PTP slave 118 implemented by DUT 114. PTP slave 118 of DUT 114 records the time T2 of receipt of the sync message.

PTP grand master 108 of test tool 100 sends a follow up message carrying the value T1 to PTP slave 118 of DUT 114. The time value T1 is the time at which PTP grand master 108 of test tool 100 transmits the sync message. At time T3, PTP slave 118 of DUT 114 sends a delay request message to PTP grand master 108 of test tool 100. PTP grand master 108 of DUT 114 responds with a delay response message carrying the value T4, which is the time at which PTP grand master 108 of test tool 100 received the delay request message. PTP slave 118 of DUT 114 receives the delay response and calculates the offset between CLK2 and clock CLK1 of PTP grand master 108 of test tool 100 as follows:

$$Offset = ( ( T 2 - T 1 ) - ( T 4 - T 3 ) ) / 2$$

PTP slave 118 of DUT 114 updates its local clock as follows:

$$CLK 2 = CLK 1 + O ffset$$

PTP master 122 of DUT 114 initiates the process of causing PTP slave 112 of test tool 100 to synchronize its local clock CLK3 with CLK2 by sending a sync message to PTP slave 112 of test tool 100. PTP slave 118 of test tool 100 records the time T2 of receipt of the sync message. PTP master 122 of DUT 114 sends a follow up message carrying the value T1 to PTP slave 112 of test tool 100. The time value T1 is the time at which PTP master 122 of DUT 114 transmits the sync message. At time T3, PTP slave 112 of test tool 100 sends a delay request message to PTP master 122 of DUT 114. PTP master 120 of DUT 114 responds with a delay response message carrying the value T4, which is the time at which PTP master 122 of DUT 114 received the delay request message. PTP slave 112 of test tool 100 receives the delay response and calculates the offset between its clock, CLK3, and clock CLK2 of PTP master 122 of DUT 114 as follows:

$$Offset = ( ( T 2 - T 1 ) - ( T 4 - T 3 ) ) / 2$$

PTP slave 112 of test tool 1100 updates its local clock as follows:

$$CLK 3 = CLK 2 + O ffset$$

The offset calculated by PTP slave 112 of test tool 100 may be used as a measure of timing error of DUT 114. Test tool 100 may repeat the synchronization process illustrated in FIG. 2 and record the sync interval as the time between successive sync messages that started the synchronization process and record a new timing offset value calculated by PTP slave 112 of test tool 100. In one example, test tool 100 may increase the sync interval between successive test iterations until the timing offset calculated by PTP slave 112 of test tool 100 exceeds a threshold value. The last sync interval before the sync interval that caused the timing offset to exceed the threshold value may be recorded as the optimal value of the sync interval for DUT 114. In another example, test tool 100 may decrease the sync interval between successive test iterations, measure the change in timing offset values and continue decreasing the sync interval until the change in timing offset is less than a threshold value. The highest sync interval that resulted in change in timing offset being less than a threshold value is recorded as the optimal sync interval of DUT 114.

### Sync Message Transmission Intervals

Test tool 100 may transmit sync messages at various predefined intervals. The following are examples of sync message intervals that may be used by test tool 100.
Low frequency: 1 per 512 second, 1 per 256 second, . . . , 1 per second
High frequency: 2 per second, 4 per second, . . . , up to 512 per second

The transmission rate is negotiated between devices using a signaling message, which includes the message interval request TLV. This TLV specifies the interval between successive sync messages. The TLV format and interval encoding are as follows:

### Sync Interval

timeSyncInterval (Integer8)

Represents the base-2 logarithm of the desired mean interval between successive sync messages.

Table 1 shown below defines the interval encoding.

TABLE 1
Interval Encoding

| Transmission Rate | Integer Value |
|---|---|
| 1 per 512 seconds | 9 |
| 1 per 256 seconds | 8 |
| 1 per 128 seconds | 7 |
| 1 per 64 seconds | 6 |
| 1 per 32 seconds | 5 |
| 1 per 16 seconds | 4 |
| 1 per 8 seconds | 3 |
| 1 per 4 seconds | 2 |
| 1 per 2 seconds | 1 |
| 1 per second | 0 |
| 2 per second | −1 |
| 4 per second | −2 |
| 8 per second | −3 |
| 16 per second | −4 |
| 32 per second | −5 |
| 64 per second | −6 |
| 128 per second | −7 |
| 256 per second | −8 |
| 512 per second | −9 |

The format of message interval request TLV is shown in Table 2 below:

TABLE 2
Message Interval Request TLV

| | | | | | | | | | Offet |
|---|---|---|---|---|---|---|---|---|---|
| | | | | | | | | | from |
| Bits | | | | | | | | | startof |
| 8 | 7 | 6 | 5 | 4 | 3 | 2 | 1 | Octets | TLV |

| | | |
|---|---|---|
| tlvType | 2 | 0 |
| lengthField | 2 | 2 |
| organizationId | 3 | 4 |
| organizationSubType | 3 | 7 |
| linkDelayInterval | 1 | 10 |
| timeSyncInterval | 1 | 11 |
| announceInterval | 1 | 12 |
| flags | 1 | 13 |
| reserved | 2 | 14 |

The sync interval value is defined as follows:

### TimeSyncInterval (Integer8)

The value is the logarithm to base 2 of the mean time interval, desired by the port that sends this TLV, between successive time-synchronization event messages sent by the port at the other end of the link. The values listed in the table below are reserved.

TABLE 3
Reserved Values of TimeSyncInterval

| | Instruction to time-aware system |
|---|---|
| Value | that receives this TLV |
| 127 | Instructs the port that receives this |
| | TLV to stop sending time- |
| | synchronization event messages. |
| 126 | Instructs the port that receives this |
| | TLV to set currentLogSyncInterval |
| | to the value of |
| | initialLogSyncInterval, see 10.6.2.3, |
| | 11.5.2.3, 12.6, and 13.9.2. |
| −128 | Instructs the port that receives this |
| | TLV not to change the mean time |
| | interval between successive time- |
| | synchronization event messages. |

### Problem Addressed

Challenges in Configuring gPTP Message Intervals Across Ethernet Profiles

Although Ethernet-based time synchronization profiles use the Generic Precision Time Protocol (gPTP), each profile defines its own time error tolerance based on application-specific requirements. For example:
IEEE 802.1AS (automotive) may require sub-microsecond accuracy.
IEEE 802.1 CM (5G fronthaul) demands nanosecond-level precision.
IEEE 60802 (industrial Automation) focuses on deterministic behaviour with strict jitter constraints.

Despite using the same protocol, these profiles impose different thresholds for acceptable time error, which directly impacts how frequently gPTP messages (e.g., Sync messages) should be exchanged.

### Challenge: Balancing Precision and Overhead

PTP device users must configure the message interval—how often timestamped messages are sent—to ensure accurate time error detection. However, this involves a trade-off:
Higher message frequency (e.g., 128 messages per second) improves precision but increases CPU load, memory usage, and network traffic.
Lower frequency reduces overhead but may fail to detect subtle time drifts, especially in high-precision environments.

### Example Scenario

Consider a device operating in a 5G fronthaul network (IEEE 802.1 CM), where the time error threshold is ±50 ns. To meet this requirement, the PTP device user might initially configure the sync interval to 8 messages per second. However, if the measured time error exceeds the threshold, the user may need to increase the rate to 16 or 32 messages per second. This adjustment requires monitoring the current time error, manually updating the message interval via the signaling message using the message interval request TLV, and reevaluating the time error after the change. This manual, iterative process is time-consuming and error-prone, especially when deploying at scale or in dynamic environments.

### Need for Automation

Due to the lack of a unified threshold standard and the complexity of tuning message intervals, vendors are forced to rely on continuous manual intervention to identify the optimal configuration for each device and profile.

### Details of the Solution

Auto-Adaptive gPTP Interval Configuration

The subject matter described herein includes an auto-adaptive mechanism for gPTP-aware devices that dynamically adjusts sync intervals based on observed time errors. This approach enables a PTP test tool to autonomously determine and apply optimal intervals, eliminating the need for manual tuning and improving synchronization accuracy.

### Implementation

1. Test tool 100 continuously monitors its time error (clock offset) relative to the clock of DUT 114.
2. Test tool 100 initiates a search algorithm, such as a binary search algorithm, to identify the optimal sync message interval. Using a binary search algorithm can include iteratively increasing sync time interval by a factor of 2 and repeating PTP synchronization using the steps illustrated in FIG. 2 until a desired value of the timing error is achieved. In another example, using the binary search algorithm can include iteratively decreasing the sync time interval by a factor of one half and repeating the PTP synchronization steps illustrated in FIG. 2 until a desired value of the timing error is achieved.
   To update the sync transmission interval, test tool 100 sends a signaling message with a new sync message transmission interval encoded in the message interval request TLV.
   Test tool 100 measures the resulting new time error value.
   Test tool 100 Iteratively adjusts the sync message transmission interval to converge on the configuration that yields a desired value of the timing error.
3. Once the optimal interval is determined, test tool 100 locks the configuration and continues operation using the best-performing interval. Different values for sync interval can be taken from the interval mapping table mentioned above.

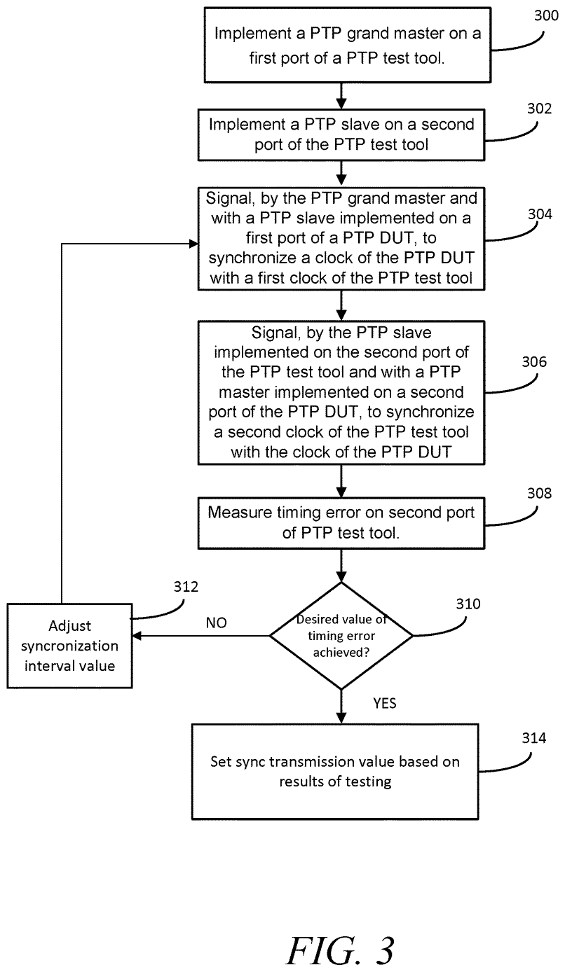

FIG. 3 is a flow chart illustrating an exemplary process for time synchronization interval optimization. Referring to FIG. 3, in step 300, the process includes implementing a PTP grand master on a first port of a PTP test tool. For example, a PTP test tool, such as PTP test tool 100, may implement a PTP grand master on one of its ports.

In step 302, the process further includes implementing a PTP slave on a second port of the PTP test tool. For example, test tool 100 may implement PTP slave 112 on one of the ports of test tool 100.

In step 304, the process further includes signaling, by the PTP grand master and with a PTP slave implemented on a first port of a PTP DUT, to synchronize a clock of the PTP DUT with a first clock of the PTP test tool. For example, PTP grand master 108 may signal with PTP slave 118 to synchronize CLK2 of DUT 114 with CLK1 of PTP test tool 100.

In step 306, the process further includes signaling, by the PTP slave implemented on the second port of the PTP test tool and with a PTP master implemented on a second port of the PTP DUT, to synchronize a second clock of the PTP test tool with the clock of the PTP DUT. For example, PTP slave 122 may signal with PTP master 112 to synchronize a clock of PTP slave 112 with a clock of PTP slave 122

In step 308, the process further includes measuring a timing error on the second port of the PTP test tool. For example, test tool 100 may calculate a timing offset between the clock of PTP slave 112 and the clock of PTP master 122.

In step 310, the process includes determining whether a desired value of the timing error has been achieved. If the desired value of the timing error has not been achieved, control proceeds to step 312 where test tool 114 adjusts the sync message transmission interval, and steps 304-310 are repeated until the desired value of the timing error is achieved. When the desired value of the timing error is achieved, control proceeds to step 314 where the test tool sets the sync transmission interval based on results of the testing.

### Benefits

The subject matter described herein may achieve at least some of the following advantages.
Eliminates manual intervention in tuning sync message transmission intervals.
Adapts dynamically to changing network conditions and device performance.
Improves synchronization accuracy while minimizing protocol overhead.
Scales efficiently across diverse Ethernet profiles and deployment scenarios.

### Importance

This solution transforms gPTP synchronization from a static, manual process into a dynamic, intelligent system. It aligns with industry trends toward automation, software-defined networking, and adaptive systems.

### Overall Idea

The overall idea of the subject matter described herein is an auto-adaptive mechanism for optimizing gPTP message intervals based on real-time clock offset measurements.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for testing a precision time protocol (PTP) device under test with PTP sync interval optimization, the method comprising:
implementing a PTP grand master on a first port of a PTP test tool;
implementing a PTP slave on a second port of the PTP test tool;
signaling, by the PTP grand master and with a PTP slave implemented on a first port of a PTP DUT, to synchronize a clock of the PTP DUT with a first clock of the PTP test tool;
signaling, by the PTP slave implemented on the second port of the PTP test tool and with a PTP master implemented on a second port of the PTP DUT, to synchronize a second clock of the PTP test tool with the clock of the PTP DUT;
measuring a timing error on the second port of the PTP test tool; and
automatically adjusting a sync message transmission interval and repeating PTP synchronization signaling between the PTP test tool and the PTP DUT until the timing error measured at the second port of the PTP test tool reaches a desired value.

2. The method of claim 1 wherein signaling, by the PTP grand master includes transmitting sync and follow_up message to the PTP slave implemented on the first port of the PTP DUT, receiving a delay_request message from the PTP slave implemented on the first port of the PTP DUT, and transmitting a delay_response message to the PTP slave implemented on the first port of the PTP DUT.

3. The method of claim 1 wherein signaling by the PTP slave implemented on the second port of the PTP test tool includes receiving sync and follow_up messages from the PTP master implemented on the second port of the PTP DUT and transmitting a delay_request message from the PTP slave implemented on the second port of the PTP test tool to the PTP master implemented on the second port of the PTP DUT.

4. The method of claim 1 wherein measuring the timing error at the second port of the PTP test tool includes calculating a timing offset value at the second port of the PTP test tool.

5. The method of claim 4 wherein calculating the timing offset value includes calculating the timing offset value as:
$$timing offset value = ( ( T 2 - T 1 ) - ( T 4 - T 3 ) ) / 2 ,$$
where T2 is a time of receipt of a sync message by the PTP slave implemented on the second port of the PTP test tool, T1 is a transmission time of the sync message by the PTP master implemented on the second port of the PTP DUT, T3 is a transmission time of a delay_request message by the PTP slave implemented on the second port of the PTP test tool, and T4 is a time of receipt of the delay_request message by the PTP master implemented on the second port of the PTP DUT.

6. The method of claim 1 wherein automatically adjusting the sync message transmission interval includes transmitting a signaling message from the second port of the PTP test tool to the second port of the PTP DUT where the signaling message encodes an updated sync message interval.

7. The method of claim 1 wherein automatically adjusting the sync message transmission interval includes automatically and iteratively increasing the sync message transmission interval until the timing error exceeds a threshold value.

8. The method of claim 7 comprising setting the sync message transmission interval to a last sync message transmission interval prior to the timing error exceeding the threshold value.

9. The method of claim 1 wherein automatically adjusting the sync message transmission interval includes automatically and iteratively decreasing the sync message transmission interval until a change in the timing error is less than a threshold value.

10. The method of claim 1 wherein automatically adjusting the sync message transmission interval includes automatically and iteratively searching for an optimal value for the sync message transmission interval using a binary search algorithm.

11. A system for testing a precision time protocol (PTP) device under test with PTP sync interval optimization, the system comprising:
a PTP test tool including first and second ports, at least one processor, and a memory;
a PTP grand master by the at least one processor on the first port of the PTP test tool;
a PTP slave implemented by the at least one processor on the second port of the PTP test tool;
the PTP grand master being configured to signal with a PTP slave implemented on a first port of a PTP DUT, to synchronize a clock of the PTP DUT with a first clock of the PTP test tool;
the PTP slave being configured to synchronize a second clock of the PTP test tool with the clock of the PTP DUT;
the PTP test tool being configured to measure a timing error on the second port of the PTP test tool, automatically adjust a sync message transmission interval, and repeat PTP synchronization signaling between the PTP test tool and the PTP DUT until the timing error measured at the second port of the PTP test tool reaches a desired value.

12. The system of claim 11 wherein the PTP grand master is configured to perform the signaling with the PTP slave implemented on the first port of the PTP DUT by transmitting sync and follow_up message to the PTP slave implemented on the first port of the PTP DUT, receiving a delay_request message from the PTP slave implemented on the first port of the PTP DUT, and transmitting a delay_response message to the PTP slave implemented on the first port of the PTP DUT.

13. The system of claim 11 wherein the PTP slave implemented on the second port of the PTP test tool is configured to perform the signaling with the PTP master by receiving sync and follow_up messages from the PTP master implemented on the second port of PTP DUT and transmitting a delay_request message from the PTP slave implemented on the second port of the PTP test tool to the PTP master implemented on the second port of the PTP DUT.

14. The system of claim 11 wherein the PTP test tool is configured to measure the timing error at the second port of the PTP test tool by calculating a timing offset value at the second port of the PTP test tool.

15. The system of claim 14 wherein the PTP test tool is configured to calculate the timing offset value by calculating the timing offset value as:
$$timing offset value = ( ( T 2 - T 1 ) - ( T 4 - T 3 ) ) / 2 ,$$
where T2 is a time of receipt of a sync message by the PTP slave implemented on the second port of the PTP test tool, T1 is a transmission time of the sync message by the PTP master implemented on the second port of the PTP DUT, T3 is a transmission time of a delay_request message by the PTP slave implemented on the second port of the PTP test tool, and T4 is a time of receipt of the delay_request message by the PTP master implemented on the second port of the PTP DUT.

16. The system of claim 11 wherein the PTP test tool is configured to automatically adjust the sync message transmission interval by transmitting a signaling message from the second port of the PTP test tool to the second port of the PTP DUT where the signaling message encodes an updated sync message interval.

17. The system of claim 11 wherein the PTP test tool is configured to automatically adjust the sync message transmission interval by automatically and iteratively increasing the sync message transmission interval until the timing error exceeds a threshold value.

18. The system of claim 11 wherein the PTP test tool is configured to automatically adjust the sync message transmission interval by automatically and iteratively decreasing the sync message transmission interval until a change in the timing error is less than a threshold value.

19. The system of claim 11 wherein the PTP test tool is configured to automatically adjust the sync message transmission interval by automatically and iteratively searching for an optimal value for the sync message transmission interval using a binary search algorithm.

20. A non-transitory computer readable medium having stored thereon executable instructions that when executed by a processor of a computer control the computer to perform steps comprising:
implementing a precision time protocol (PTP) grand master on a first port of a PTP test tool;
implementing a PTP slave on a second port of the PTP test tool;
implementing a PTP slave on a second port of the PTP test tool;
signaling, by the PTP grand master and with a PTP slave implemented on a first port of a PTP DUT, to synchronize a clock of the PTP DUT with a first clock of the PTP test tool;
signaling, by the PTP slave implemented on the second port of the PTP test tool and with a PTP master implemented on a second port of the PTP DUT, to synchronize a second clock of the PTP test tool with the clock of the PTP DUT;
measuring a timing error on the second port of the PTP test tool; and
automatically adjusting a sync message transmission interval and repeating PTP synchronization signaling between the PTP test tool and the PTP DUT until the timing error measured at the second port of the PTP test tool reaches a desired value.
